(19) United States
(12) Patent Application Publication
(10) Pub. No.: US 2025/0106168 A1
(43) Pub. Date: Mar. 27, 2025

(54) METHOD AND APPARATUS FOR CANCELLING DELAY STATUS REPORT IN WIRELESS COMMUNICATION SYSTEM

(71) Applicant: SAMSUNG ELECTRONICS CO., LTD., Suwon-si (KR)

(72) Inventors: Weiping SUN, Suwon-si (KR); Hyunjeong KANG, Suwon-si (KR); Sangkyu BAEK, Suwon-si (KR)

(21) Appl. No.: 18/900,308

(22) Filed: Sep. 27, 2024

(30) Foreign Application Priority Data
Sep. 27, 2023 (KR) 10-2023-0131162

(51) Int. Cl. H04L 47/32

(52) U.S. Cl. CPC H04L 47/32

(57) ABSTRACT

The disclosure relates to a 5G or 6G communication system for supporting a higher data transmission rate. A method performed by a user equipment (UE) in a wireless communication system is provided. The method includes receiving, from a base station (BS), a radio resource control (RRC) message configuring a remaining time threshold for a delay status report (DSR), identifying a packet data convergence protocol (PDCP) service data unit (SDU) associated with the DSR based on the remaining time threshold, determining a PDCP data volume to be indicated to at least one medium access control (MAC) entity based on the PDCP SDU associated with the DSR, and transmitting, to the BS, a DSR MAC control element (CE) based on the PDCP data volume.

### CROSS-REFERENCE TO RELATED APPLICATION

This application is based on and claims priority under 35 U.S.C. § 119 to Korean Patent Application No. 10-2023-0131162, filed on Sep. 27, 2023, in the Korean Intellectual Property Office, the disclosure of which is incorporated by reference herein in its entirety.

### BACKGROUND

### 1. Field

The disclosure relates to operations of a user equipment (UE) and a base station (BS) in a wireless communication system, and more particularly, to a method and apparatus for cancelling a delay status report of data.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication. Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

In order for a base station (BS) to efficiently allocate an uplink (UL) resource, according to the developments of a mobile communication system, there is an increasing demand for a user equipment (UE) to report various pieces of information to the BS.

Additional aspects will be set forth in part in the description which follows and, in part, will be apparent from the description, or may be learned by practice of the presented embodiments of the disclosure.

In accordance with an aspect of the disclosure, a method performed by a user equipment (UE) in a wireless communication system is provided. The method includes receiving, from a base station (BS), a radio resource control (RRC) message configuring a remaining time threshold for a delay status report (DSR), identifying a packet data convergence protocol (PDCP) service data unit (SDU) associated with the DSR based on the remaining time threshold, determining a PDCP data volume to be indicated to at least one medium access control (MAC) entity based on the PDCP SDU associated with the DSR, and transmitting, to the BS, a DSR MAC control element (CE) based on the PDCP data volume.

In accordance with another aspect of the disclosure, a user equipment (UE) in a wireless communication system is provided. The UE includes a transceiver, and a controller, wherein the controller is configured to receive, from a base station (BS) via the transceiver, a radio resource control (RRC) message configuring a remaining time threshold for a delay status report (DSR), identify a packet data convergence protocol (PDCP) service data unit (SDU) associated with the DSR based on the remaining time threshold, determine a PDCP data volume to be indicated to at least one medium access control (MAC) entity based on the PDCP SDU associated with the DSR, and transmit, to the BS via the transceiver, a DSR MAC control element (CE) based on the PDCP data volume.

The technical features of the disclosure which are aimed to achieve in various embodiments of the disclosure are not limited to the aforementioned features, and other unstated technical features will be clearly understood by one of ordinary skill in the art in view of descriptions below.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of an NR system according to an embodiment of the present disclosure;

FIG. 2 illustrates a radio protocol architecture in an NR system according to an embodiment of the present disclosure;

FIG. 3 illustrates a data volume corresponding to a remaining time of data in a buffer of a UE for each delay status report (dsr)-logical channel (lch) (dsr-lch) according to an embodiment of the present disclosure;

FIG. 4 illustrates a remaining time reference time according to an embodiment of the present disclosure;

FIG. 5 illustrates a PDCP discard operation with respect to a plurality of PDUs of a PDU set according to an embodiment of the present disclosure;

FIG. 6 illustrates an RRC signaling procedure performed by a gNB and a UE so as to configure whether the UE supports a DSR and DSR-associated information according to an embodiment of the present disclosure;

FIG. 7 illustrates a structure of a BS according to an embodiment of the present disclosure; and

FIG. 8 illustrates a structure of a UE according to an embodiment of the present disclosure.

### DETAILED DESCRIPTION

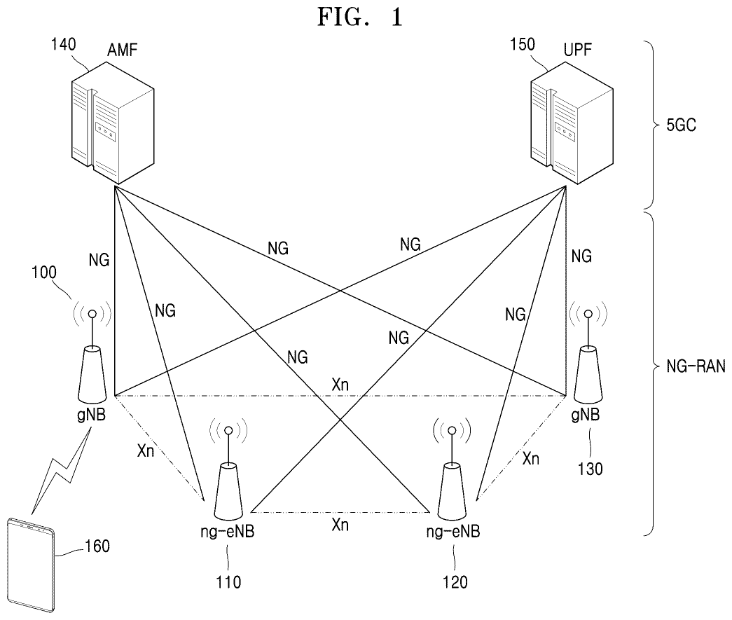

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Throughout the disclosure, the expression “at least one of a, b or c” indicates only a, only b, only c, both a and b, both a and c, both b and c, all of a, b, and c, or variations thereof.

Throughout the specification, a layer may also be referred to as an entity.

Hereinafter, embodiments of the disclosure will now be described more fully with reference to the accompanying drawings. Here, it should be noted that the same reference numerals denote the same components in the accompanying drawings. Also, detailed descriptions of well-known functions and configurations which may obscure the disclosure are not provided.

In the following descriptions of embodiments of the disclosure, descriptions of techniques that are well known in the art and are not directly related to the disclosure are omitted. By omitting unnecessary descriptions, the essence of the disclosure may not be obscured and may be explicitly conveyed.

For the same reason, some elements in the drawings are exaggerated, omitted, or schematically illustrated. Also, size of each element does not exactly correspond to an actual size of each element. In each drawing, elements that are the same or are in correspondence are rendered the same reference numeral.

Advantages and features of the disclosure and methods of accomplishing the same may be understood more readily by reference to the following detailed descriptions of embodiments and accompanying drawings of the disclosure. The disclosure may, however, be embodied in many different forms and should not be construed as being limited to the embodiments set forth herein. Rather, these embodiments of the disclosure are provided so that this disclosure will be thorough and complete, and will fully convey the concept of the disclosure to one of ordinary skill in the art. Therefore, the scope of the disclosure is defined by the appended claims. Throughout the specification, like reference numerals refer to like components.

It will be understood that each block of flowchart illustrations, and combinations of blocks in the flowchart illustrations, may be implemented by computer program instructions. The computer program instructions may be provided to a processor of a general-purpose computer, special purpose computer, or other programmable data processing apparatus, such that the instructions, which are executed via the processor of the computer or other programmable data processing apparatus, generate means for performing functions specified in the flowchart block(s). The computer program instructions may also be stored in a computer-executable or computer-readable memory that may direct the computer or other programmable data processing apparatus to function in a particular manner, such that the instructions stored in the computer-executable or computer-readable memory may produce an article of manufacture including instruction means that perform the functions specified in the flowchart block(s). The computer program instructions may also be loaded onto the computer or other programmable data processing apparatus to cause a series of operational steps to be performed on the computer or other programmable apparatus to produce a computer implemented process such that the instructions that are executed on the computer or other programmable apparatus provide operations for implementing the functions specified in the flowchart block(s).

In addition, each block of the flowchart illustrations may represent a module, segment, or portion of code, which includes one or more executable instructions for performing specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The term “ . . . unit” as used an embodiment of the disclosure refers to a software or hardware component, such as field-programmable gate array (FPGA) or application-specific integrated circuit (ASIC), which performs certain tasks. However, the term “ . . . unit” does not mean to be limited to software or hardware. A “ . . . unit” may be configured to be in an addressable storage medium or configured to operate one or more processors. Thus, according to an embodiment of the disclosure, a “ . . . unit” may include, by way of example, components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided in the elements and “ . . . units” may be combined into fewer elements and “ . . . units” or further separated into additional elements and “ . . . units.” Further, the elements and “ . . . units” may be implemented to operate one or more central processing units (CPUs) in a device or a secure multimedia card.

Hereinafter, a base station is an entity that allocates resources to a terminal, and may be at least one of a Node B, a base station (BS), an evolved node B (eNode B), a next-generation node B (gNB, gNode B), a radio access unit, a BS controller, or a node on a network. A terminal may include a user equipment (UE), a mobile station (MS), a 5G UE, a cellular phone, a smartphone, a computer, or a multimedia system capable of performing a communication function. Furthermore, embodiments of the disclosure may also be applied to other communication systems having similar technical backgrounds or channel types. Furthermore, embodiments of the disclosure are applicable to other communication systems through modification at the discretion of one of ordinary skill in the art without greatly departing from the scope of the disclosure. For example, embodiments of the disclosure may be applicable to a system including 5^{th} generation (5G) New Radio (NR) communication technology developed after LTE-A system, and hereinafter, 5G may indicate a concept including LTE, LTE-A, and other similar services according to the related art. Furthermore, the disclosure is applicable to other communication systems through modification at the discretion of one of ordinary skill in the art without greatly departing from the scope of the disclosure.

Hereinafter, terms identifying an access node, terms indicating network entities or network functions (NFs), terms indicating messages, terms indicating an interface between network entities, and terms indicating various pieces of identification information, as used in the following description, are exemplified for convenience of explanation. Accordingly, the disclosure is not limited to terms to be described below, and other terms indicating objects having equal technical meanings may be used.

For convenience of descriptions, the disclosure may use some of terms and names defined in the 3^{rd} Generation Partnership Project (3GPP) long term evolution (LTE) standards and/or 3GPP New Radio (NR). However, the disclosure is not limited to these terms and names, and may be equally applied to communication systems conforming to other standards.

FIG. 1 illustrates a structure of an NR system according to an embodiment of the present disclosure.

Referring to FIG. 1, a wireless communication system may include a plurality of BSs (e.g.: a gNB 100, an ng-eNB 110, an ng-eNB 120, and a gNB 130), an access and mobility management function (AMF) 140, a user plane function (UPF) 150, etc. However, the wireless communication system is not limited to the configuration of FIG. 1, and may include more elements or fewer elements than the shown elements.

According to an embodiment of the disclosure, a UE (or terminal) 160 may access an external network via the BSs 100, 110, 120, and 130 and the UPF 150.

With reference to FIG. 1, the BSs 100, 110, 120, and 130 are access nodes of a cellular network and may provide radio accesses to UEs that access the network. For example, in order to service users' traffic, the BSs 100, 110, 120, and 130 may collect state information such as a buffer state, an available transmission power state, a channel state, or the like of the UEs 160 and may perform scheduling, based on the collected information, so as to support connection between the UEs 160 and a core network (CN; in particular, a CN of NR is referred to as 5GC).

With reference to FIG. 1, the gNB 100 or 130 may control a plurality of cells, and may use adaptive modulation & coding (AMC) to determine a modulation scheme and a channel coding rate in accordance with a channel state of the UE 160.

The CN is an entity to perform a mobility management function and various control functions with respect to a UE and may be connected to the BSs 100, 110, 120, and 130 Also, the 5GC may interoperate with a legacy LTE system.

The wireless communication system may be configured of a user plane (UP) associated with transmission of actual user data and a control plane (CP) associated with connection management, etc. The gNB 100 and the gNB 130 of FIG. 1 may use a UP and CP-associated technology defined in the NR technology, and although the ng-eNB 110 and the ng-eNB 120 are connected to the 5GC, the ng-eNB 110 and the ng-eNB 120 may use a UP and CP-associated technology defined in the LTE technology.

The AMF 140 may be an entity to perform a mobility management function and various control functions with respect to the UE 160 and may be connected to the plurality of BSs 100, 110, 120, and 130.

The UPF 150 may be a gateway to provide data transmission. Although not shown in FIG. 1, the NR wireless communication system may include a session management function (SMF). The SMF may manage packet data network connection such as a protocol data unit (PDU) session provided to the UE 160.

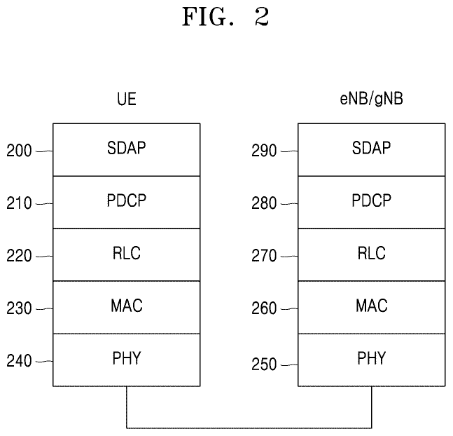

FIG. 2 illustrates a radio protocol architecture in an NR system according to an embodiment of the present disclosure.

Referring to FIG. 2, the radio protocol architecture of the NR system may include service data adaptation protocol (SDAP) layers 200 and 290, packet data convergence protocol (PDCP) layers 210 and 280, radio link control (RLC) layers 220 and 270, medium access control (MAC) layers 230 and 260, and physical (PHY) layers 240 and 250 respectively for a UE and eNB/gNB.

The SDAP layers 200 and 290 may each perform an operation of transferring user data, and performing mapping between a quality of service (QoS) flow and a specific data radio bearer (DRB) for both uplink (UL) and downlink (DL), an operation of marking a QoS flow identifier (ID) in both UL and DL, and an operation of performing mapping between a reflective QoS flow and a DRB for UL SDAP PDUs. An SDAP configuration corresponding to each DRB may be provide from an upper radio resource control (RRC) layer. However, the present disclosure is not limited to the example above.

The PDCP layers 210 and 280 may each perform an operation for Internet Protocol (IP) header compression and decompression, etc. Also, the PDCP layers 210 and 280 may each provide an in-sequence or out-of-sequence delivery function, a reordering function, a duplicate detection function, a retransmission function, and a ciphering and deciphering function. However, the disclosure is not limited to the example above.

The RLC layers 220 and 270 may each reconfigure PDCP PDUs to appropriate sizes. Also, the RLC layers 220 and 270 may each provide an in-sequence or out-of-sequence delivery function, an automatic repeat request (ARQ) function, a concatenation, segmentation and reassembly function, a re-segmentation function, a duplicate detection function, and an error detection function. However, the disclosure is not limited to the example above.

The MAC layers 230 and 260 may each be connected to a plurality of RLC layer entities configured for one UE and may each perform an operation of multiplexing RLC PDUs into a MAC PDU and demultiplexing the RLC PDUs from the MAC PDU. Also, the MAC layers 230 and 260 may each provide a mapping function, a scheduling information reporting function, a hybrid ARQ (HARQ) function, a function of priority handling between logical channels, a function of priority handling between UEs, a multimedia broadcast/multicast service (MBMS) service identification function, a transport format selection function, and a padding function. However, the disclosure is not limited to the example above.

The PHY layers 240 and 250 may each perform an operation of channel-coding and modulating upper layer data into orthogonal frequency division multiplexing (OFDM) symbols and transmitting the OFDM symbols through a wireless channel, or demodulating OFDM symbols received through a wireless channel and channel-decoding and delivering the OFDM symbols to an upper layer. Also, the physical layer may use a HARQ for additional error correction, and a receiving end may transmit, in 1 bit, information about whether a packet transmitted by a transmitting end is received. The 1-bit information may be referred to as HARQ acknowledgement (ACK)/negative ACK (NACK) information.

In the LTE system, DL HARQ ACK/NACK information about UL data transmission may be transmitted on a physical hybrid-ARQ indicator channel (PHICH) physical channel, and in the NR system, as asynchronous HARQ is applied, the NR system may determine whether retransmission or new transmission is requested, based on UE scheduling information on a physical dedicated control channel (PDCCH) that is a channel on which DL/UL resource allocation is transmitted. UL HARQ ACK/NACK information about DL data transmission may be transmitted on a physical uplink control channel (PUCCH) or physical uplink shared channel (PUSCH) physical channel. In general, the PUCCH is transmitted in a UL of a primary cell (PCell) to be described below, but, when a UE supports, a BS may allow a secondary cell (SCell) to additionally transmit the PUCCH to the UE, and this SCell is referred to as the PUCCH SCell.

Although not illustrated in FIG. 2, RRC layers may be respectively present above the PDCP layers of the UE and the eNB/gNB, and the RRC layers may each transmit or receive configuration control messages related to access and measurement to control radio resources.

The PHY layer may be configured of one or more frequencies/carriers, and a technology by which a plurality of frequencies is simultaneously configured and used is referred to as a carrier aggregation (CA) technology. Compared with using only one carrier for communication between a UE (or terminal) and a BS (eNB or gNB), according to the CA technology, one main carrier and one or more subcarriers are additionally used such that an amount of data transmission may be increased as much as the number of subcarriers. In the LTE/NR system, a cell in a BS which uses a main carrier is referred to as a primary cell or PCell, and a cell in the BS which uses subcarrier is referred to as a secondary cell or SCell.

In the next-generation/5G (NR) wireless communication system, in order to assist a BS in further efficiently scheduling a resource, it is requested for a UE to report a buffer status to the BS. A buffer status report (BSR) indicates a UL data volume stored in a buffer of the UE, and may be used in reporting. According to the specification of the NR system, the UE may select a period index including a buffer UL data volume to be reported from among an UL data volume range for each period defined for each index in a buffer size table, and may include the period index in a BSR.

The BSR in the NR system may be performed based on MAC layer signaling between the UE and the BS. For example, when a BSR is triggered at a particular transmission time, the UE may include a BSR MAC control element (MAC CE) in a MAC PDU and may transmit the MAC PDU to the BS. Here, the BSR MAC CE may indicate a packet volume in a unit of a logical channel group (LCG) which remains in a transport buffer of the UE after the MAC PDU is configured. The BS may estimate, by using the received BSR, the UL data volume currently remaining in the buffer of the UE. In the NR system, the UE may manage the transport buffer of UL data to be transmitted to the BS, for each of eight LCGs.

Extended reality (XR) UL data may have a valid delay budget, e.g., a remaining time that is a remaining valid delay budget. The corresponding UL data may be used as valid data only when the UL data arrives to a UL server within a preset remaining time, based on a time of the UL data being generated in an application layer. If the UL data does not arrive to the UL server within the preset remaining time, the corresponding data may lose an application value thereof. A UE buffer size reported in the BSR may be designed to report an entire UL data volume store in the buffer of the UE. However, the BS may not identify how much of entire UL data is closer to a delay budget, e.g., how much data has a short remaining time. If the BS identifies a remaining time of UL data and a UL data volume corresponding to each of remaining times in the buffer of the UE, the BS may reflect that in allocation of UL resources such that data with a relatively short remaining data can be first transmitted.

Therefore, more UL data may be transmitted before a remaining time expires, and thus, a cell capacity may be improved. On the other hand, in a case of specific UL data of which remaining time is very short, a time from the BSR to actual transmission may be equal to or longer than the remaining time. In this case, the data may be transmitted after an application value thereof is already lost or may be even discarded before a transmission time. Accordingly, it is not possible to load valid data on an allocated UL resource, such that a waste of resource may be caused. If information reported to the BS includes a remaining time satisfying a pre-defined specific remaining time reference (upper bound or lower bound), or the remaining time and a data volume, the BS may further efficiently allocate a UL resource to the UE by using the information.

According to an embodiment of the disclosure, provided is a method of reporting a remaining time of UL data stored in a transport buffer of a UE and/or volumes of a plurality of pieces of data corresponding to remaining times to a BS, and using the reporting in UL scheduling by the BS.

When at least one of conditions below is satisfied, the UE may trigger a BSR in a cell group corresponding to the satisfied condition:
Condition 1-1: When new UL data occurs in a logical channel (LCH) included in an LCG, and priority of the LCH precedes priority of other LCH having UL data. Here, it may be regarded that a triggered regular BSR is triggered by the LCH in which the new UL data occurs;
Condition 1-2: When new UL data occurs in a LCH included in an LCG, and before occurrence of the new UL data, all LCHs included in all LCGs do not have UL data. Here, it may be regarded that a triggered regular BSR is triggered by the LCH in which the new UL data occurs; and/or
Condition 1-3: In expiry of retxBSR-Timer, when UL data exists in at least one LCH, and the LCH is included in an LCG. Here, it may be regarded that a triggered regular BSR is triggered by a LCH having highest priority from among the at least one LCH having UL data.

According to an embodiment of the disclosure, in a case where a regular BSR is already triggered, and logicalChannelSR-DelayTimer of a LCH that triggered the regular BSR is not running, the UE may trigger, for the regular BSR, a scheduling request (SR) corresponding to the LCH when at least one of conditions below is satisfied:
Condition 2-1: When there is no uplink-shared channel (UL-SCH) resource for initial transmission or new transmission;
Condition 2-2: A corresponding MAC entity is configured with configured grant(s), and the LCH that triggered the regular BSR is configured with false with respect to logicalChannelSR-Mask; and/or
Condition 2-3: Although there is a UL-SCH resource for initial transmission, the UL-SCH resource cannot be used for the LCH that triggered the regular BSR, due to logical channel prioritization (LCP) mapping restriction.

Here, the logicalChannelSR-Mask may be a parameter for controlling SR triggering when configured grant is configured.

According to an embodiment of the disclosure, the UE may report a remaining time state of UL data in the transport buffer via a specific MAC CE to the BS. For example, the MAC CE may be referred to as a delay status report (DSR) MAC CE.

According to an embodiment of the disclosure, with reference to a DSR, the BS may configure at least one of information below with respect to a specific MAC entity (or cell group) of the UE via an RRC message.

Whether to report a remaining time may be configured for each of LCH/LCG. According to an embodiment of the disclosure, LCH/LCG for which a remaining time is reported may be referred to as delay status report (dsr)-logical channel group (lcg) (dsr-lcg)/delay status report (dsr)-logical channel (lch) (dsr-lch). For example, when a specific LCG is configured as dsr-lcg, all LCHs included in the LCG may be regarded as dsr-lchs. For example, an LCG including one or more dsr-lchs may be regarded as dsr-lcg. For example, LCG/LCH configured with a DSR report remaining time reference or a DSR trigger remaining time reference may be regarded as dsr-lcg/dsr-lch.

DSR report remaining time reference may be set. The reference may be a remaining time upper bound, a remaining time lower bound, or remaining time upper and lower bounds. For example, when the remaining time upper bound is configured, the UE may report a remaining time and/or a buffer size with respect to UL data of which remaining time is equal to or less than the configured remaining time upper bound. For example, when the remaining time lower bound is configured, the UE may report a remaining time and/or a buffer size with respect to UL data of which remaining time is equal to or greater than the configured remaining time lower bound. For example, when the remaining time upper and lower bounds are configured, the UE may report a remaining time and/or a buffer size with respect to UL data of which remaining time is equal to or greater than the lower bound and is equal to or less than the upper bound. For example, one or more remaining time references may be configured for each LCH or each LCG or each MAC entity or each UE. For example, when the DSR report remaining time reference is not set, the DSR trigger remaining time reference may be regarded as the DSR report remaining time reference. For example, when a plurality of DSR report remaining time references or a plurality of DSR trigger remaining time references are set, a DSR may be triggered for each of the DSR trigger remaining time references, or a DSR for UL data having a remaining time satisfying a reference may be reported for each of the DSR report remaining time references or each of the DSR trigger remaining time references.

An upper bound to the number of remaining time fields may be configured. For example, an upper bound to the number of pairs of a remaining time field and a buffer size field for each remaining time may be configured. The upper bound to the number may be configured for each LCH or each LCG or an entire DSR MAC CE. When the upper bound to the number of remaining time fields is configured, a DSR may include a number of remaining time fields or a number of pairs of a remaining time field and a buffer size field for each remaining time, the number being less than or equal to the upper bound of a maximum number configured by the BS for each LCH or each LCG or an entire DSR MAC CE.

A DSR trigger remaining time reference may be set. For example, the DSR trigger remaining time reference may be a remaining time upper bound, a remaining time lower bound, or remaining time upper and lower bounds. The DSR trigger remaining time reference may be configured for each LCH or each LCG or each MAC entity or each UE. For example, when the DSR trigger remaining time reference is not separately set, the DSR trigger remaining time reference may be determined by changelessly applying a DSR report remaining time reference of corresponding LCH/LCG/MAC entity/cell group/UE or by introducing a specific offset. The offset may be predetermined or may be configured by a BS via RRC. For example, one or more DSR trigger remaining time references may be provided for each LCG.

According to an embodiment of the disclosure, all of value/field/variable/parameter associated with a remaining time may be expressed in the form of an integer having a specific time unit. The integer may express an absolute time, or a relative time based on a specific time. For example, the time unit may have one unit or a combination form from among a microsecond, a millisecond, a second, a symbol, a slot, a subframe, a frame, etc.

According to an embodiment of the disclosure, a pre-defined remaining time table may be provided in the rules, and each index/codepoint included in the table may indicate a specific remaining time period. Different index/codepoint of the remaining time table may indicate different remaining time periods that do not overlap each other. A maximum remaining time included in the table may be equal to a maximum value of discardTimer configured in PDCP-Config of 3GPP standard specification TS 38.331 rules, or may be a value having the corresponding maximum value and specific offset. Last index/codepoint of the table may indicate all time periods that are equal to or greater than the maximum remaining time. For example, when the remaining time table includes a number of indexes/codepoints, the number being equal to 2^{k} or equal to or less than 2^{k} but greater than 2^{k-1}, a remaining time field or a minimum remaining time field of a DSR may have a length of k-bit.

According to an embodiment of the disclosure, all of value/field/variable/parameter associated with a remaining time may be expressed as specific index/codepoint of the remaining time table. For example, when a value indicated by a remaining time field of a DSR or a remaining time upper bound or lower bound configured by the BS is t, this may mean index/codepoint t of the remaining time table.

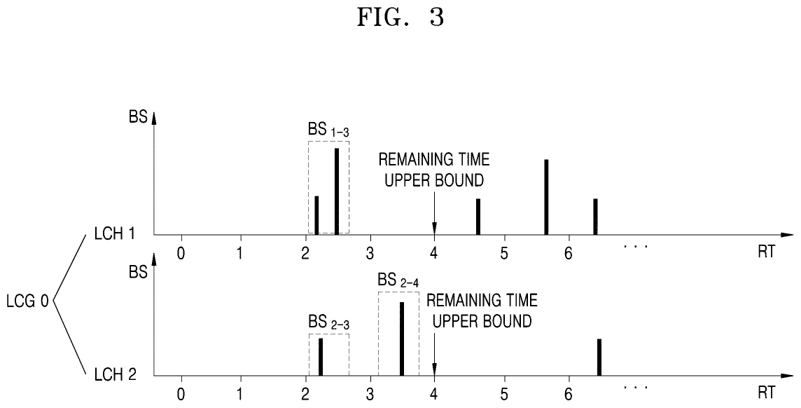

FIG. 3 illustrates a UL data volume corresponding to a remaining time of UL data in a buffer of a UE, for each dsr-lch according to an embodiment of the present disclosure.

According to an embodiment of the disclosure, the UE may report a remaining time status of UL data in a corresponding LCG buffer, for each dsr-lcg, via a DSR.

According to an embodiment of the disclosure, when index/codepoint of a remaining time table are indicated by a remaining time filed, a minimum classification period of a remaining time which is reported via the DSR may be a period indicated by each index/codepoint, and when an integer having a particular time unit is indicated, the minimum classification period may be the time unit.

According to an embodiment of the disclosure, a remaining time or a buffer size for each remaining time or a delay-critical buffer size which is reported via a DSR may be reported with respect to UL data that exists in specific LCH/LCG/MAC entity/cell group buffer and excludes UL data included in a MAC PDU after the MAC PDU including a DSR MAC CE is configured.

The DSR MAC CE may include one or more pieces of information below.
1) LCH or LCG indicator
   2) LCG/LCH ID field or specific position bit of a bitmap may indicate corresponding LCG/LCH. For example, the LCG/LCH indicator may be used to indicate a remaining time field corresponding to the DSR MAC CE, or a minimum remaining time field, or a pair of (minimum) remaining time field and a buffer size filed for corresponding remaining time, or existence or non-existence of a delay-critical buffer size field.
1) Remaining time field
   2) When a BS configured only a remaining time reference and did not configure an upper bound to the number of remaining time fields, for each LCH or each LCG or entire MAC entity/cell group:
      3) the UE may report a remaining time of UL data which satisfies a remaining time reference from among UL data in (one or more) dsr-lch buffer(s), for each LCH or each LCG or entire MAC entity/cell group. For example, when UL data corresponding to a buffer exists, for a minimum classification period of a remaining time, the UE may add a corresponding remaining time field so as to indicate a corresponding remaining time period. Referring to FIG. 3, for example, when the BS configures 4 as a remaining time upper bound for LCH 1 and LCH 2, and the UE reports a remaining time for each LCG, two remaining time fields may correspond to LCG 0 (including LCH 1 and LCH 2), and may respectively indicate remaining time 3 (reflecting BS₁₋₃ of LCH 1 and BS₂₋₃ of LCH 2) and remaining time 4 (reflecting BS₂₋₄ of LCH 2).
   2) When the BS configures all of a remaining time reference and an upper bound to the number of remaining time fields for each LCH or each LCG or an entire DSR MAC CE:
      3) the UE may report a remaining time of UL data which satisfies a remaining time reference from among UL data in corresponding (one or more) dsr-lch buffer(s), for each LCH or each LCG or entire MAC entity/cell group. For example, when UL data corresponding to a buffer exists, for a minimum classification period of a remaining time, the UE may add a corresponding remaining time field so as to indicate a corresponding remaining time period. For example, the number of remaining time fields for each LCH or each LCG or entire MAC entity/cell group may exist up to an upper bound or (upper bound−1) to the number of remaining time fields for each LCH or each LCG or an entire DSR MAC CE which is configured by the BS. For example, a remaining time field may be added in order in which a remaining time increases from a remaining time field with a shortest remaining time. Referring to FIG. 3, when the BS configures 4 as a remaining time upper bound for LCH 1 and LCH 2, and configures 1 as an upper bound to the number of remaining time fields of LCG 0, one remaining time field may correspond to LCG 0 and may indicate remaining time 3 (reflecting BS₁₋₃ of LCH 1 and BS₂₋₃ of LCH 2).
   2) When the BS does not configure a remaining time reference but only configures an upper bound to the number of remaining time fields for each LCH or each LCG or an entire DSR MAC CE:
      3) the UE may indicate a remaining time of UL data in corresponding (one or more) dsr-lch buffer(s), for each LCH or each LCG or entire MAC entity/cell group. Here, when corresponding UL data exists, for a minimum classification period, the UE may add a corresponding remaining time field so as to indicate a corresponding remaining time period. For example, the number of remaining time fields for each LCH or each LCG or entire MAC entity/cell group may exist up to an upper bound or (upper bound−1) to the number of remaining time fields for each LCH or each LCG or an entire DSR MAC CE which is configured by the BS. For example, a remaining time field may be added in order in which a remaining time increases from a remaining time field with a shortest remaining time. Referring to FIG. 3, for example, when the BS configures 1 as an upper bound to the number of remaining time fields of LCG 0, and the UE reports a remaining time for each LCG, one remaining time field may correspond to LCG 0 and may indicate remaining time 3 (reflecting BS₁₋₃ of LCH 1 and BS₂₋₃ of LCH 2).
1) Minimum remaining time field: the UE may add a remaining time field for a remaining time period including a remaining time of UL data with a shortest remaining time from among UL data in corresponding (one or more) dsr-lch buffer(s), for each LCH or each LCG or entire MAC entity/cell group, and may indicate the remaining time period. The remaining time period may be referred to as a minimum remaining time field. For example, when the BS configures a remaining time reference, the minimum remaining time field may be added only when a corresponding remaining time period satisfies the remaining time reference configured by the BS. Referring to FIG. 3, for example, when the BS configures 4 as an upper bound to the number of remaining time fields of LCG 0, and the UE reports a remaining time for each LCG, LCG 0 may have one minimum remaining time field, and the field may indicate remaining time 3.
1) (minimum) remaining time buffer size field: When there are one or more remaining time fields corresponding to specific LCH/LCG/MAC entity/cell group, or there is a minimum remaining time filed corresponding to specific LCH/LCG/MAC entity/cell group, the (minimum) remaining time buffer size field indicating a UL data volume that has a remaining time included in a remaining time period indicated by the field and is included in corresponding LCH/LCG/MAC entity/cell group buffer may be included for each remaining time or each minimum remaining time field. Referring to FIG. 3, for example, when a remaining time upper bound configured for LCG 0 by the BS is 4, and the UE reports a remaining time for each LCG, two remaining time fields may correspond to LCG 0, and the fields may respectively indicate remaining time 3 and remaining time 4.

For example, one buffer size field for each remaining time corresponding to a remaining time field indicating the remaining time 3 may be added. Here, the field may indicate BS₁₋₃+BS₂₋₃ that is a buffer size corresponding to the remaining time 3. For example, one buffer size field for each remaining time corresponding to a remaining time field indicating the remaining time 4 may be added. Here, the field may indicate BS₂₋₄ that is a buffer size corresponding to the remaining time 4.
1) Delay-critical buffer size field: When the BS configures a remaining time reference for each LCH/LCG/MAC entity/cell group, a delay-critical buffer size field indicating a UL data volume having a remaining time satisfying the remaining time reference configured by the BS from among UL data in corresponding (one or more) dsr-lch buffer(s) may be included. The number of the delay-critical buffer size fields may exist according to the remaining time reference configured by the BS, for each LCH/LCG/MAC entity/cell group. For example, when the BS configures reference 1 having remaining time upper bound 1 and reference 2 having upper bound 2 and lower bound 2 for specific LCH/LCG/MAC entity/cell group, two delay-critical buffer size fields may correspond to the corresponding LCH/LCG/MAC entity/cell group.

For example, the first delay-critical buffer size field may indicate an UL data volume having a remaining time satisfying reference 1, and the second delay-critical buffer size field may indicate a UL data volume having a remaining time satisfying reference 2. For example, the BS may configure a list in which remaining time references are formed as a plurality of integers. Here, when the integers are arranged in ascending order, two adjacent values may be regarded as one remaining time reference, and may be regarded as a lower bound and an upper bound of the one remaining time reference. Also, the smallest value may be regarded as an upper bound of a specific remaining time reference, and the specific remaining time reference may be a remaining time reference having only the upper bound.

For example, when the BS configures a remaining time reference as [x1, x2, x3](e.g., x1<x2<x3), the UE may interpret that the BS configured three remaining time references which are 1) a remaining time reference in which x1 is an upper bound, 2) a remaining time reference in which x1 is a lower bound and x2 is an upper bound, and 3) a remaining time reference in which x2 is a lower bound and x3 is an upper bound.

In the present disclosure, a remaining time reference may indicate a DSR report remaining time reference or a DSR trigger remaining time reference, which is configured via RRC by the BS.

For example, the (minimum) remaining time buffer size field or the delay-critical buffer size field may indicate an index of a buffer size period corresponding thereto in a buffer size table in which respective indices of pre-defined buffer size periods are defined. The buffer size table may be one of a long buffer size (BS) Table for 8-bit buffer size field defined in the NR system, a short BS table for a 5-bit buffer size field, and one or more New BS Tables which may be newly defined at a later time. When the candidate BS Table is provided in plural, a BS Table indicator indicating which BS Table the (minimum) remaining time buffer size field or the delay-critical buffer size field refers to may be included in a DSR MAC CE for the (minimum) remaining time buffer size field or the delay-critical buffer size field or each LCH or each LCG or each MAC entity/cell group.

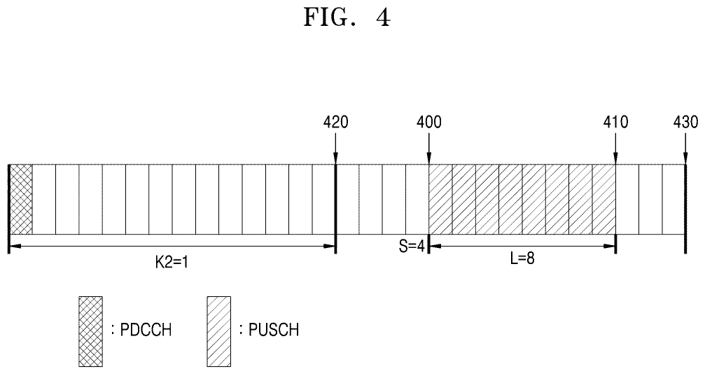

FIG. 4 illustrates a remaining time reference time according to an embodiment of the present disclosure.

According to an embodiment of the disclosure, FIG. 4 illustrates remaining time reference time which is indicated by a remaining time field or a minimum remaining time field of a DSR MAC CE or is applied by a delay-critical buffer size field. According to an embodiment of the disclosure, the remaining time reference time may be interpreted to indicate at which time the corresponding remaining time refers to.

Referring to FIG. 4, in general, a UE may transmit a MAC PDU or a transport block (TB) including a DSR MAC CE to a BS on a PUSCH resource allocated by the BS. According to an embodiment of the disclosure, the PUSCH resource may be a specific PUSCH resource allocated to the UE via dynamic scheduling by the BS. Alternatively, a plurality of periodic PUSCH resources may be allocated to the UE via configured grant (CG). The remaining time reference time which is indicated by the remaining time field or the minimum remaining time field of the DSR MAC CE or is applied by the delay-critical buffer size field may be determined based on one of options below.
A start time 400 of a first symbol of a PUSCH resource for initial transmission of the MAC PDU or the TB which includes the DSR MAC CE
An end time 410 of a last symbol of the PUSCH resource for initial transmission of the MAC PDU or the TB which includes the DSR MAC CE
A start time 420 of a slot including the PUSCH resource for initial transmission of the MAC PDU or the TB which includes the DSR MAC CE
An end time 430 of the slot including the PUSCH resource for initial transmission of the MAC PDU or the TB which includes the DSR MAC CE

According to an embodiment of the disclosure, the PUSCH resource may be a resource that BS allocated via Dynamic Grant by Dynamic Scheduling or allocated via Configured Grant.

According to an embodiment of the disclosure, a DSR may have added thereto one or more reference time fields indicating the remaining time reference time. For example, the reference time field may be a field indicating a reference time at which a remaining time value indicated by the remaining time field or UL data indicated by the delay-critical buffer size field of the DSR is calculated. For example, the reference time field may indicate an absolute time, or a relative time based on a specific time. For example, the reference time field may be expressed as one unit or a combination from among a frame, a subframe, a slot, and a symbol. For example, the reference time field may indicate an entirety of a universal time coordinated (UTC) time or a specific position/number of bits or a specific position/number of least significant bits (LSBs) or a specific position/number of most significant bits (MSBs).

According to an embodiment of the disclosure, the remaining time field of the DSR may be a field that does not indicate an absolute remaining time but indicates a relative difference compared to a specific remaining time upper bound configured by the BS. For example, the relative difference may be a value obtained by subtracting the remaining time from the remaining time upper bound, or may be a value indicating how many times smaller or greater, or how much ratio it has, when comparing the remaining time upper bound with the remaining time.

According to an embodiment of the disclosure, a remaining time of UL data in a dsr-lch buffer at a specific time may be equal to a remaining time value of PDCP discardTimer of the UL data or may be equal to a value obtained by applying specific offset to the remaining time value of PDCP discardTimer, based on the corresponding time. The offset may be pre-defined or may be configured via RRC by the BS.

According to an embodiment of the disclosure, a remaining time of a specific PDU included in a specific PDU set at a specific reference time may be regarded/configured/reconfigured as a remaining time of a PDU having a smallest remaining time, a remaining time of a PDU first generated in an application, or a remaining time of a PDU first arrived to a PDCP layer, from among all PDUs included in the PDU set at the specific reference time.

According to an embodiment of the disclosure, the remaining time of the specific PDU included in the specific PDU set at the specific reference time may be regarded/configured/reconfigured as a remaining time of a PDU having a smallest remaining time, a remaining time of a PDU first generated in an application, or a remaining time of a PDU first arrived to a PDCP layer, from among all PDUs included in the PDU set at the specific reference time, when QoS flow of the PDU set is configured with PDU-Set integrated handling information (PSIHI) or DRB/PDCP entity/QoS flow of the PDU set is configured with discard in a PDU set unit (e.g., pdu-SetDiscard).

According to an embodiment of the disclosure, the remaining time of the specific PDU included in the specific PDU set at the specific reference time may be regarded/configured/reconfigured, when the PDU set is configured with PDU set level PDCP discardTimer, as a remaining time of PDU set level PDCP discardTimer of the PDU set, based on the corresponding time, or as a value obtained by applying specific offset configured by the BS to the remaining time.

According to an embodiment of the disclosure, when a remaining time of all PDUs included in a specific PDU set at a specific time is calculated, the remaining time may be calculated as a remaining PDU set delay budget (PSDB) or a remaining access network (AN) PSDB of a corresponding PDU set, or may be calculated as a value obtained by applying specific offset to a corresponding remaining time value. The offset may be pre-defined or may be configured via RRC by the BS.

For example, a PSDB of a specific QoS flow may be defined as below.
The PDU set delay budget (PSDB) defines an upper bound for the delay that a PDU set may experience for the transfer between the UE and the N6 termination point at the UPF, i.e., the duration between the reception time of the first PDU (at the N6 termination point for DL or the UE for UL) and the time when all PDUs of a PDU set have been successfully received (at the UE for DL or N6 termination point for UL).

According to an embodiment of the disclosure, an AN PSDB of a specific QoS flow may be calculated as a value obtained by subtracting a CN PDB of the corresponding QoS flow from a PSDB of the corresponding QoS flow.

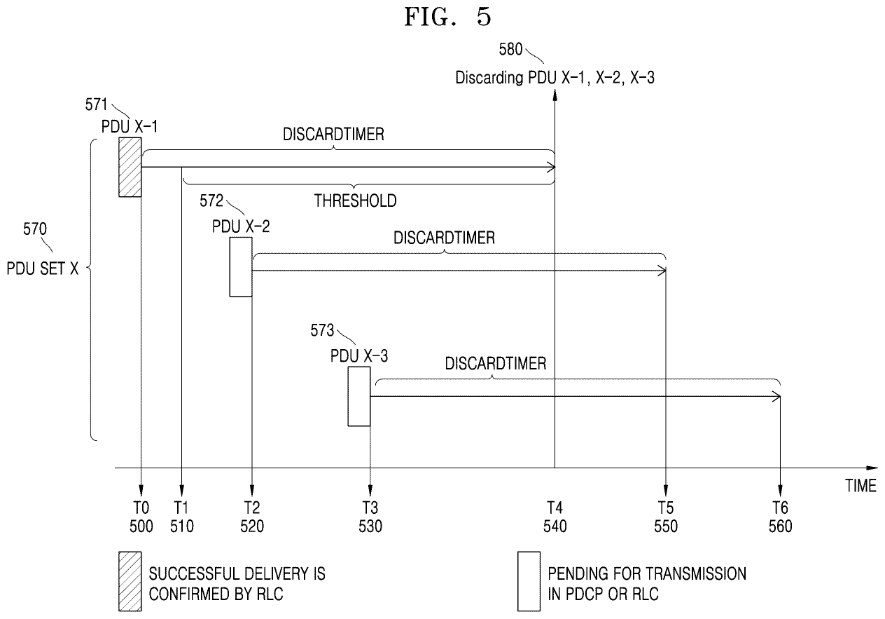

FIG. 5 illustrates an operation of a UE with respect to a PDU set when the PDU set includes a plurality of PDUs, and the plurality of PDUs arrive to a PDCP layer of the UE at different times according to an embodiment of the present disclosure.

Referring to FIG. 5, when a specific PDU set 570 includes a plurality of PDUs 571, 572, and 573, the plurality of PDUs 571, 572, and 573 arrive from an upper layer of the UE to a PDCP layer of the UE at different times 500, 520, and 530. For example, a plurality of PDUs of a specific PDU set may each arrive in the form of a PDCP SDU to a PDCP layer. For example, when a new PDCP SDU occurs, a PDCP entity may run discardTimer dedicated to the PDCP SDU. For example, a duration time from start to expiry of discardTimer of a specific PDCP SDU may be determined based on a discardTimer setting value of corresponding DRB/QoS flow by a setting value for each DRB/QoS flow. Therefore, a plurality of PDCP SDUs each including a plurality of PDUs of a specific PDU set may have the same discardTimer setting value. If a plurality of PDUs 561, 562, and 563 of a specific PDU set arrive to a PDCP entity at different times, even when a plurality of PDCP SDUs corresponding thereto have the same discardTimer setting value, an expiry time of each discardTimer may vary.

For example, a BS may configure, via an RRC message, the UE to perform a PDCP SDU discard operation due to expiry of PDCP discardTimer, in a PDU set unit. For example, the BS may indicate a discard operation in the PDU set unit by configuring pdu-SetDiscard or configuring True for pdu-SetDiscard.

For example, when discardTimer of a specific PDCP SDU of the UE expires, a corresponding PDCP entity may operate as below.
When a PDU corresponding to the PDCP SDU is included in a specific PDU set, PDCP SDUs and PDCP data PDUs which correspond to all PDUs of the PDU set may be discarded. For example, referring to FIG. 5, when discardTimer of PDU X-1 of PDU set X first expires, compared to other PDUs (PDU X-2 and PDU X-3), PDCP SDUs and PDCP data PDUs which correspond to all PDUs (PDU X-1, PDU X-2, and PDU X-3) of PDU set X may be discarded at the expiry 540 of the discardTimer of the PDU X-1. For example, the discard operation in the PDU set unit may be performed only when PSIHI is configured for QoS flow that corresponds to the PDU set. For example, the discard operation in the PDU set unit may be performed only when the BS configured pdu-SetDiscard for PDCP entity/DRB. For example, the discard operation in the PDU set unit may be performed only when the BS configured pdu-SetDiscard for PDCP entity/DRB/QoS flow, and PSIHI is configured for QoS flow corresponding to the PDU set.
If the PDCP data PDU to be discarded is already transferred to a lower layer (e.g., an RLC layer), discard with respect to the PDCP data PDU may also be indicated to the lower layer.

According to an embodiment of the disclosure, a DSR MAC CE trigger condition may be at least one of conditions below.
Condition 3-1: When UL data satisfying a DSR trigger remaining time reference occurs in specific dsr-lcg/dsr-lch, and UL data satisfying the corresponding reference does not exist in a MAC entity or a cell group or an LCG which includes the dsr-lcg/dsr-lch, a DSR MAC CE may be triggered. For example, occurrence of the UL data satisfying the DSR trigger remaining time reference may mean that new UL data satisfying the reference occurs, or a remaining time of UL data existing in a buffer is decreased to satisfy the reference. For example, a DSR triggered by the condition may be referred to as regular DSR. For example, priority of LCG may be determined as priority of LCH of which priority is highest from among LCHs included in a corresponding LCG.
Condition 3-2: When UL data satisfying a DSR trigger remaining time reference occurs in specific dsr-lcg/dsr-lch, and a LCH/LCG priority level of the UL data is higher than a LCH/LCG priority level of another UL data of a MAC entity or a cell group or an LCG which corresponds to the dsr-lcg/dsr-lch, the other UL data satisfying the reference, a DSR MAC CE may be triggered. For example, occurrence of the UL data satisfying the DSR trigger remaining time reference may mean that new UL data satisfying the reference occurs, or a remaining time of existing UL data is decreased to satisfy the reference. For example, a DSR triggered by the condition may be referred to as regular DSR.
Condition 3-3: When UL data satisfying a DSR trigger remaining time reference occurs in specific dsr-lcg/dsr-lch, and a remaining time of the UL data is less than a remaining time of another UL data of a MAC entity or a cell group or an LCG which corresponds to the dsr-lcg/dsr-lcg, the other UL data satisfying the reference, a DSR MAC CE may be triggered. Occurrence of the UL data satisfying the DSR trigger remaining time reference may mean that new UL data satisfying the reference occurs, or a remaining time of existing UL data is decreased to satisfy the reference. For example, a DSR triggered by the condition may be referred to as regular DSR.
Condition 3-4: When a DSR retransmission timer (e.g., retxDSR-Timer) is configured, and the timer expires, if UL data satisfying a DSR trigger remaining time reference exists in at least one dsr-lcg/dsr-lch, a DSR MAC CE may be triggered. For example, retxDSR-Timer may be a timer different from retxBSR-Timer (BSR retransmission timer). For example, retxDSR-Timer may be the same timer as retxBSR-Timer (BSR retransmission timer). For example, retxDSR-Timer size may be configured for each MAC entity/cell group/LCG by the BS via RRC. For example, a DSR triggered due to expiry of retxDSR-Timer may be regarded that LCH/LCG having the highest priority are triggered from among dsr-lcg/dsr-lch including UL data satisfying a DSR trigger remaining time reference, at the expiry of the timer. The timer may start/restart when a UL-SCH resource includes a DSR MAC CE and a corresponding subheader after the UL-SCH resource that is available went through logical channel prioritization (LCP). For example, the DSR triggered by the expiry of the timer may be referred to as regular DSR.
Condition 3-5: When a periodic DSR timer (e.g., periodicDSR-Timer) is configured, and the timer expires, a DSR MAC CE may be triggered. For example, the timer may be a timer different from periodicBSR-Timer (periodic BSR timer). For example, the timer may be the same timer as periodicBSR-Timer (periodic BSR timer). For example, the timer may start/restart when a UL-SCH resource includes a DSR MAC CE and a corresponding subheader, other than a truncated DSR, after the UL-SCH resource that is available went through LCP. For example, periodicDSR-Timer size may be configured for each MAC entity/cell group/LCG by the BS via RRC. For example, when the size of the timer is configured to infinity, the timer may not expire, and thus, DSR triggering due to expiry of the timer may not occur.
Condition 3-6: When padding bit occurs as a result of LCP with respect to a specific UL-SCH, in a case where UL data satisfying a DSR trigger remaining time reference exists in at least one dsr-lcg/dsr-lch or a case where a length of the padding bit is equal to or greater than a total length of a DSR MAC CE and a corresponding subheader, a padding DSR that is transmitted instead of the padding bit may be triggered. For example, a truncated DSR may indicate a DSR MAC CE including only a report on some dsr-lcg which can be contained in the padding bit, when a length of the padding bit cannot contain a report on all dsr-lcg including UL data volume (buffer size) that is greater than 0 and satisfies a remaining time reference, in the padding DSR transmitted using the padding bit. For example, Truncated DSR/Truncated Long DSR/Truncated Short DSR may be allocated specific LCID/eLCID different from DSR/Long DSR/Short DSR.
Condition 3-7: When a remaining time of UL data having a shortest remaining time from among UL data of specific dsr-lcg satisfies a DSR trigger remaining time reference, corresponding to dsr-lcg which is configured by the BS, a DSR may be triggered. For example, the DSR trigger remaining time reference may be a remaining time upper bound, and that the remaining time reference is satisfied may mean that a remaining time is less than or equal to the remaining time upper bound. For example, the DSR trigger remaining time reference may include a remaining time lower bound or remaining time lower bound and upper bound.
Condition 3-8: When there is UL data, from among UL data of specific dsr-lcg, which has a remaining time that satisfies a DSR trigger remaining time reference that corresponds to corresponding dsr-lcg, a DSR may be triggered.

For example, from among the conditions 3-1 to 3-8, that UL data satisfying a DSR trigger remaining time reference exists/occurs in specific dsr-lcg/dsr-lch may mean at least one of options below.
Option 1: This may indicate a case, with respect to a corresponding LCG/LCH, in which a remaining time satisfies a DSR trigger remaining time reference, and a PDU not included in a PDU set exists in a PDCP/RLC buffer.
Option 2: This may indicate a case in which a remaining time of a first/first-arrived PDU of a specific PDU set of a corresponding LCG/LCH satisfies a DSR trigger remaining time reference, and a segment of at least one PDU/PDU in the PDU set exists in a PDCP/RLC buffer. For example, a case in which one or more PDUs of the PDU set have not yet arrived to a corresponding PDCP entity of the UE may also be included in Option 2. For example, Option 2 may be valid only for a case in which PSIHI is configured for QoS flow of the corresponding PDU set or a case in which pdu-SetDiscard is configured for corresponding PDCP entity/DRB/QoS flow of the corresponding PDU set.
Option 3: This may indicate a case in which a remaining time of a first/first-arrived PDU of a specific PDU set of a corresponding LCG/LCH satisfies a DSR trigger remaining time reference, and the PDU set includes one or more PDU/PDU Segments that are not yet arrived from an upper layer to a PDCP layer or that exist in a PDCP/RLC buffer. For example, a case in which the PDCP/RLC buffer does not have a PDU/PDU segment included in the PDU set but has a PDU/PDU segment not yet arrived from an upper layer to the PDCP layer may also be included in Option 3. For example, Option 3 may be valid only for a case in which PSIHI is configured for QoS flow of the corresponding PDU set or a case in which pdu-SetDiscard is configured for corresponding PDCP entity/DRB/QoS flow of the corresponding PDU set.
Option 4: This may indicate a case in which a remaining time of a first/first-arrived PDU of a specific PDU set of a corresponding LCG/LCH satisfies a DSR trigger remaining time reference, and all PDUSs included in the PDU set already arrived from an upper layer to a PDCP layer, or one or more PDU/PDU Segments exist in a PDCP/RLC buffer. For example, Option 4 may be valid only for a case in which PSIHI is configured for QoS flow of the corresponding PDU set or a case in which pdu-SetDiscard is configured for corresponding PDCP entity/DRB/QoS flow of the corresponding PDU set.
Option 5: The BS may configure, via an RRC message, validity of at least one option from among Option 1 to Option 4.

For example, in order to prevent too many DSRs from being excessively triggered, the UE may apply at least one options below.
UL data of LCG/LCH/MAC entity that triggered a DSR that is pending and not cancelled may be driven not to further trigger a DSR. For example, when a DSR trigger remaining time reference of LCG/LCH/MAC entity including UL data to trigger a new DSR includes a remaining time upper bound, and the upper bound is less than other LCG/LCH/MAC entity that already triggered a DSR, the UL data may trigger a DSR. For example, SR configuration for DSR may be configured for each LCG, and when a DSR is triggered by a specific LCG, SR of the LCG may be triggered.
For example, when other PDU included in the same PDU set has triggered a DSR that is not cancelled yet, the PDU may be driven not to additionally trigger a DSR.
Even when there is a plurality of DSRs that are pending and not cancelled yet, one MAC PDU may maximally include one DSR MAC CE.

According to an embodiment of the disclosure, when specific UL grant includes all available pending data but cannot include a DSR MAC CE and a corresponding subheader, all triggered DSRs may be cancelled. For example, when specific UL grant includes all pending data to be reported by a DSR (for example, all pending data to be reported by a delay-critical buffer size field/a (minimum) remaining time buffer size field) but cannot include a DSR MAC CE and a corresponding subheader, all triggered DSRs may be cancelled. For example, when a DSR MAC CE is included in a specific MAC PDU, and buffer/remaining time states of all DSR trigger events (including buffer/remaining time states of a last DSR trigger event) which occurred before a corresponding MAC PDU assembly are reported by a DSR, all DSRs triggered before the corresponding MAC PDU assembly may be cancelled. For example, when UL data (PDU/PDU set) having a remaining time satisfying a corresponding trigger remaining time reference does not exist in specific dsr-lch/dsr-lcg/MAC entity/cell group (or when delay-critical UL data size of the dsr-lch/dsr-lcg/MAC entity/cell group is 0), if DSRs that are pending and not cancelled yet after being triggered exists in the dsr-lch/dsr-lcg/MAC entity/cell group, the DSRs may be all cancelled.

According to an embodiment of the disclosure, a remaining time of UL data (PDU/PDU set) which is 0 may be regarded not to satisfy all remaining time references. For example, in a case where a DSR trigger remaining time reference of a specific dsr-lcg includes only a remaining time upper bound, even when the DSR trigger remaining time reference does not include a remaining time lower bound, it may be regarded that only UL data (e.g., PDU/PDU set) having a remaining time being less than or equal to the upper bound and greater than 0 satisfies the DSR trigger remaining time reference.

According to an embodiment of the disclosure, when a DSR MAC CE is included in a specific MAC PDU, and a buffer state of all BSR trigger events (including a buffer state of a last BSR trigger event) which occurred before a corresponding MAC PDU assembly is reported by a DSR, all BSRs triggered before the corresponding MAC PDU assembly may be cancelled. This may mean that, as a size of all available data in a buffer is reported by a DSR, there is no need to additionally transmit a BSR.

According to an embodiment of the disclosure, in order to trigger a DSR or configure a delay-critical buffer size field and/or a (minimum) remaining time buffer size field which is reported by the DSR, a MAC layer of the UE may request a RLC layer and a PDCP layer of the UE for a UL data volume that satisfies a specific remaining time reference and is included in a buffer of each corresponding layer.

According to an embodiment of the disclosure, a buffer size for each LCH/LCG which is indicated by a delay-critical buffer size field or a (minimum) remaining time buffer size field which is reported by a DSR may indicate a total sum of UL data that satisfies a corresponding remaining time reference and does not include UL data included in a MAC PDU including the DSR, from among UL data in all RLC and PDCP buffers corresponding to the LCH/LCG. For example, the buffer size indicated by the delay-critical buffer size field or the (minimum) remaining time buffer size field which is reported by the DSR may indicate a data size existing in the RLC and PDCP buffers after a MAC PDU Assembly including a DSR MAC CE.

For example, when calculating the buffer size for each LCH/LCG which is indicated by the delay-critical buffer size field or the (minimum) remaining time buffer size field which is reported by the DSR, in a case where at least one PDU of a specific PDU set is already arrived from an upper layer to a PDCP layer, a remaining time of a PDU of the PDU set which is first/first arrived to the PDCP layer satisfies a corresponding remaining time reference, and one or more PDUs of the PDU set are not arrived to the PDCP layer, a PDU of the PDU set which is not yet arrived to the PDCP layer may also be included in the buffer size.

For example, when calculating the buffer size for each LCH/LCG which is indicated by the delay-critical buffer size field or the (minimum) remaining time buffer size field which is reported by the DSR, in a case where at least one PDU of the specific PDU set is already arrived from the upper layer to the PDCP layer, a remaining time of a PDU of the PDU set which is first/first arrived to the PDCP layer satisfies a corresponding remaining time reference, and one or more PDUs of the PDU set are not arrived to the PDCP layer, only when PSIHI is configured for QoS flow of the PDU set, a PDU of the PDU set which is not yet arrived at the PDCP layer may also be included in the buffer size.

For example, when determining a (minimum) remaining time buffer size field for each LCH/LCG, if there is a PDU set including a PDU that is first/first arrived to the PDCP layer and has a remaining time satisfying a corresponding remaining time reference, and one or more PDUs of the PDU set are not yet arrived to the PDCP layer, a remaining time of the PDU set may not be reported.

For example, when determining the (minimum) remaining time buffer size field for each LCH/LCG, if there is a PDU set including a PDU that is first/first arrived to the PDCP layer and has a remaining time satisfying the corresponding remaining time reference, and one or more PDUs of the PDU set are not yet arrived to the PDCP layer, a remaining time of the PDU set may not be reported only when PSIHI is configured for QoS flow of the PDU set.

For example, when determining the (minimum) remaining time buffer size field for each LCH/LCG, if there is a PDU set including a PDU that is first/first arrived to the PDCP layer and has a remaining time satisfying the corresponding remaining time reference, and one or more PDUs of the PDU set are not yet arrived to the PDCP layer, a remaining time of the PDU set may be reported.

For example, when determining the (minimum) remaining time buffer size field for each LCH/LCG, if there is a PDU set including a PDU that is first/first arrived to the PDCP layer and has a remaining time satisfying the corresponding remaining time reference, and one or more PDUs of the PDU set are not yet arrived to the PDCP layer, a remaining time of the PDU set may be reported only when PSIHI is configured for QoS flow of the PDU set.

According to an embodiment of the disclosure, PDCP/RLC/MAC layers of the UE may identify an entire PDU set size and whether PSIHI is configured with respect to a specific PDU set of a specific QoS flow, according to implementation of the UE.

According to an embodiment of the disclosure, the MAC/RLC layers of the UE may receive, from the PDCP layer, an indication of the entire PDU set size or whether PSIHI is configured with respect to the specific PDU set of the specific QoS flow.

According to an embodiment of the disclosure, the MAC layer of the UE may request the RLC layer for a UL data volume satisfying a specific remaining time reference. When the RLC layer determines the UL data volume satisfying the specific remaining time reference, at least one from among a plurality of pieces of UL data below may be included. For example, PDU/PDU set included in the UL data below may be regarded as PDU/PDU set existing in an RLC buffer. For example, in the disclosure, a corresponding remaining time reference may indicate a DSR trigger remaining time reference or a DSR report remaining time reference.
An RLC SDU and an RLC SDU segment which are not yet included in an RLC data PDU and satisfy the corresponding remaining time reference. For example, in a case where a PDU corresponding to the RLC SDU/SDU segment is included in a specific PDU set, only when a remaining time of a PDCP SDU corresponding to a PDU of the PDU set which is first/first arrived to a PDCP layer satisfies the corresponding remaining time reference, the RLC SDU/SDU segment may be included in a UL data volume of the RLC layer which satisfies the remaining time reference. For example, the operation may be performed only when PSIHI is configured for QoS flow of the corresponding PDU set or when pdu-SetDiscard is configured for corresponding PDCP entity/DRB/QoS flow of the corresponding PDU set.
An RLC data PDU that is in queue for initial transmission and satisfies the remaining time reference. For example, in a case where a PDU corresponding to the RLC data PDU is included in a specific PDU set, only when a remaining time of a PDCP SDU corresponding to a PDU of the PDU set which is first/first arrived to a PDCP layer satisfies the corresponding remaining time reference, the RLC data PDU may be included in a UL data volume of the RLC layer which satisfies the remaining time reference. For example, the operation may be performed only when PSIHI is configured for QoS flow of the corresponding PDU set or when pdu-SetDiscard is configured for corresponding PDCP entity/DRB/QoS flow of the corresponding PDU set.
An RLC data PDU that is in queue for RLC retransmission and satisfies the remaining time reference, in an RLC acknowledged mode (AM) mode. For example, in a case where a PDU corresponding to the RLC data PDU is included in a specific PDU set, only when a remaining time of a PDCP SDU corresponding to a PDU of the PDU set which is first/first arrived to a PDCP layer satisfies the corresponding remaining time reference, the RLC data PDU may be included in a UL data volume of the RLC layer which satisfies the remaining time reference. For example, the operation may be performed only when PSIHI is configured for QoS flow of the corresponding PDU set or when pdu-SetDiscard is configured for corresponding PDCP entity/DRB/QoS flow of the corresponding PDU set.

According to an embodiment of the disclosure, a determining method/scheme as to whether specific RLC SDU/SDU segment/data PDU satisfy a specific remaining time reference may be determined by internal implementation of the UE.

According to an embodiment of the disclosure, determination as to whether the specific RLC SDU/SDU segment/data PDU satisfy the specific remaining time reference may be determined by an indication from a corresponding PDCP entity.

According to an embodiment of the disclosure, determination as to whether the specific RLC SDU/SDU segment/data PDU satisfy the specific remaining time reference may be determined by whether a remaining time of PDCP discardTimer of the RLC SDU/SDU segment/data PDU satisfies the specific remaining time reference. For example, determination as to how long the remaining time of PDCP discardTimer of the RLC SDU/SDU segment/data PDU may be determined by internal implementation of the UE.

According to an embodiment of the disclosure, the MAC layer of the UE may request the PDCP layer for a UL data volume satisfying the specific remaining time reference. Here, when the PDCP layer determines the UL data volume that satisfies the specific remaining time reference, at least one from among a plurality of pieces of UL data below may be included. For example, PDU/PDU set included in the UL data below may be regarded as PDU/PDU set existing in a PDCP buffer.
A PDCP SDU that does not yet constitute a PDCP data PDU and satisfies the corresponding remaining time reference. For example, in a case where a PDU corresponding to the PDCP SDU is included in a specific PDU set, only when a remaining time of a PDCP SDU corresponding to a PDU of the PDU set which is first/first arrived to a PDCP layer satisfies the corresponding remaining time reference, the PDCP SDU may be included in a UL data volume of the PDCP layer which satisfies the remaining time reference. For example, the operation may be performed only when PSIHI is configured for QoS flow of the corresponding PDU set or when pdu-SetDiscard is configured for corresponding PDCP entity/DRB/QoS flow of the corresponding PDU set.
A PDCP data PDU that is not yet transferred to a lower layer (MAC or RLC) and satisfies the remaining time reference. For example, in a case where a PDU corresponding to the PDCP data PDU is included in a specific PDU set, only when a remaining time of a PDCP SDU corresponding to a PDU of the PDU set which is first/first arrived to a PDCP layer satisfies the corresponding remaining time reference, the PDCP data PDU may be included in a UL data volume of the PDCP layer which satisfies the remaining time reference. For example, the operation may be performed only when PSIHI is configured for QoS flow of the corresponding PDU set or when pdu-SetDiscard is configured for corresponding PDCP entity/DRB/QoS flow of the corresponding PDU set.
A PDCP SDU that is in queue for retransmission caused by PDCP entity re-establishment in an AM DRB, and satisfies the remaining time reference. For example, in a case where a PDU corresponding to the PDCP SDU is included in a specific PDU set, only when a remaining time of a PDCP SDU corresponding to a PDU of the PDU set which is first/first arrived to a PDCP layer satisfies the corresponding remaining time reference, the PDCP SDU may be included in a UL data volume of the PDCP layer which satisfies the remaining time reference. For example, the operation may be performed only when PSIHI is configured for QoS flow of the corresponding PDU set or when pdu-SetDiscard is configured for corresponding PDCP entity/DRB/QoS flow of the corresponding PDU set.
A PDCP data PDU that is in queue for retransmission caused by PDCP data recovery in an AM DRB, and satisfies the remaining time reference. For example, in a case where a PDU corresponding to the PDCP data PDU is included in a specific PDU set, only when a remaining time of a PDCP SDU corresponding to a PDU of the PDU set which is first/first arrived to a PDCP layer satisfies the corresponding remaining time reference, the PDCP data PDU may be included in a UL data volume of the PDCP layer which satisfies the remaining time reference. For example, the operation may be performed only when PSIHI is configured for QoS flow of the corresponding PDU set or when pdu-SetDiscard is configured for corresponding PDCP entity/DRB/QoS flow of the corresponding PDU set.
A remaining time of a PDCP SDU corresponding to a PDU of a specific PDU set which is first/first arrived to the PDCP layer satisfies a corresponding remaining time reference, one or more PDUs of the PDU set which are not yet arrived to the PDCP layer may also be included in a UL data volume of the PDCP layer which satisfies the remaining time reference. For example, the operation may be performed only when PSIHI is configured for QoS flow of the corresponding PDU set or when pdu-SetDiscard is configured for corresponding PDCP entity/DRB/QoS flow of the corresponding PDU set.

According to an embodiment of the disclosure, when a PDCP entity associated with at least two RLC entities informs a MAC entity about a PDCP data volume satisfying a specific remaining time reference, the PDCP entity may operate as below.
1) Case of a radio bearer (RB) in which a PDCP duplication function is activated:
   2) The PDCP entity may inform a UL data volume thereof to a MAC entity associated with a primary RLC entity, the UL data volume satisfying the corresponding remaining time reference.
   2) The PDCP entity may inform a UL data volume thereof to a MAC entity associated with an RLC entity that is activated for a PDCP duplication function and excludes the primary RLC entity, the UL data volume excluding a PDCP Control PDU from among a plurality of pieces of UL data satisfying the corresponding remaining time reference.
   2) The PDCP entity may inform a MAC entity that a UL data volume that satisfies the corresponding remaining time reference is 0, the MAC entity being associated with an RLC entity that is deactivated for a PDCP duplication function.
1) Case of an RB or a dual active protocol stack (DAPS) bearer in which a PDCP duplication function is deactivated:
   2) When a split secondary RLC entity is configured, and a total volume of a PDCP data volume and an RLC data volume that is for initial transmission and exists in a primary RLC entity and the split secondary RLC entity, which satisfy a corresponding remaining time reference, is equal to or greater than a specific threshold configured by the BS:
      3) The PDCP entity may inform a PDCP data volume thereof to two MAC entities associated with the primary RLC entity and the split secondary RLC entity, the PDCP data volume satisfying the corresponding remaining time reference. For example, the PDCP entity may inform a MAC entity that the PDCP data volume satisfying the corresponding remaining time reference is 0, the MAC entity being associated with an RLC entity other than the primary RLC entity and the split secondary RLC entity.
   2) Case where a transmitting PDCP entity is a DAPS bearer:
      3) Case where UL data switching is not requested:
         4) The transmitting PDCP entity may inform a PDCP data volume thereof to a MAC entity associated with a source cell, the PDCP data volume satisfying the corresponding remaining time reference.
      3) Case where UL data switching is requested:
         4) The transmitting PDCP entity may inform a PDCP data volume thereof to a MAC entity associated with a target cell, the PDCP data volume satisfying the corresponding remaining time reference.
   2) Other case:
      3) The transmitting PDCP entity may inform a PDCP data volume thereof to a MAC entity associated with a primary RLC entity, the PDCP data volume satisfying the corresponding remaining time reference.
      3) The transmitting PDCP entity may inform a MAC entity that the PDCP data volume satisfying the corresponding remaining time reference is 0, the MAC entity being associated with an RLC entity other than the primary RLC entity.

According to an embodiment of the disclosure, the BS may indicate network congestion to the UE via a PDCP Control PDU, a specific MAC CE, or a specific RRC message.

According to an embodiment of the disclosure, the BS may indicate or trigger the UE to perform a PDU set importance (PSI)-based discard operation, via a PDCP Control PDU, a specific MAC CE, or a specific RRC message.

For example, the PSI-based discard operation may follow at least one of operations below.
Option 1: A PDCP entity of the UE for one or more DRBs configured by the BS may apply a new PDCP discardTimer value configured by the BS to a PDCP SDU that already arrived or is to arrive. Alternatively, the UE may configure an additional timer as well as PDCP discardTimer, and when the additional timer expires, the UE may operate to discard the PDCP SDU. For example, when PSI of a PDU set of a PDU that corresponds to the PDCP SDU or the PDU that corresponds to the PDCP SDU to which the new PDCP discardTimer setting value or a new timer is applied is not included in a specific PDU set, new PDCP discardTimer/new timer which correspond to BS-configured PSI or each PSI period may be applied, based on the PSI of the PDU. For example, the new PDCP discardTimer setting value or the new timer may be applied to only a PDCP SDU that corresponds to PDU set/PDU with less importance than a PSI threshold configured by the BS (less importance means that a PSI value is equal to or less than the PSI threshold or is equal to or greater than the PSI threshold).
Option 2: The PDCP entity of the UE for one or more DRBs configured by the BS may perform a discard operation on PDU set/PDU with less PSI than a PSI threshold for each UE/DRB configured by the BS (less PSI means that the PSI is equal to or less than the PSI threshold or is equal to or greater than the PSI threshold). For example, the discard operation may be performed on UL data existing in a PDCP layer and/or an RLC layer. For example, the discard operation may be performed on UL data having already arrived to the PDCP layer. For example, the discard operation may be performed on UL data that is to arrive to the PDCP layer.

For example, the BS may indicate the UE to suspend (or cancel) the PSI-based discard operation, by transmitting a PDCP Control PDU, a specific MAC CE, or a specific RRC message to the UE. For example, when the UE starts the PSI-based discard operation, the UE may run a specific timer configured by the BS, and when the timer expires, the UE may suspend (or cancel) the PSI-based discard operation.

Due to the PSI-based discard operation, a remaining time of UL existing in a buffer of the UE may be decreased than before. For example, in the PSI-based discard operation, as a new PDCP discardTimer value or a new timer is applied to a remaining time of specific PDU set/PDU, the remaining time of the PDU set/PDU may be configured, based on the new PDCP discardTimer value or the new timer.

For example, while the UE performs the PSI-based discard operation or receives an indication of network congestion from the BS, the UE may exclude or not consider PDU set/PDU in DSR trigger/report/cancel related operations, the PDU set/PDU having less PSI than a specific PSI threshold configured by the BS (less PSI means that the PSI is equal to or less than the PSI threshold or is equal to or greater than the PSI threshold).

For example, after a DSR MAC CE to be included in specific UL Grant is configured, when new UL data that satisfies a corresponding remaining time reference occurs in specific dsr-lch/dsr-lcg or UL data that satisfied the corresponding remaining time reference is discarded due to the PSI-based discard operation, the UE may update, before transmitting a MAC PDU including the DSR MAC CE, information to be reported via the DSR MAC CE, based on a new buffer state.

For example, when a MAC entity of the UE receives a report indicating that (delay critical) UL data/buffer sizes satisfying the corresponding remaining time reference are 0, from RLC and PDCP entities corresponding to all dsr-lch/dsr-lcg of the MAC entity, the MAC entity may cancel all DSRs that are pending and not cancelled.

For example, the MAC entity of the UE may trigger a DSR when a change (e.g., an increase or decrease in a buffer size) of at least threshold configured by the BS for each LCH/LCG/MAC entity/cell group occurs in UL data/buffer sizes for each (delay critical) LCH/LCG/MAC entity which satisfy the corresponding remaining time reference, the buffer sizes being reported from RLC and PDCP entities corresponding to dsr-lch/dsr-lcg/cell group of the MAC entity, compared to a buffer size that satisfies the corresponding remaining time reference for each LCH/LCG/MAC entity and is most recently reported by a DSR MAC CE.

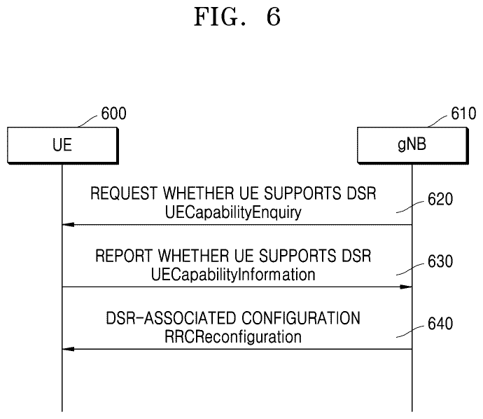

FIG. 6 illustrates an RRC signaling procedure performed by a gNB 610 and a UE 600 so as to configure whether the UE 600 supports a DSR and DSR-associated information according to an embodiment of the present disclosure.

Referring to FIG. 6, in operation 620, the gNB 610 may transfer/transmit a UECapabilityEnquiry message requesting the UE 600 in an RRC_CONNECTED state to report a capability. The gNB 610 may include a UE capability enquiry for each of radio access technology (RAT) types, in the UECapabilityEnquiry message. The UE capability enquiry for each of the RAT types may include requested frequency band information. Also, when the gNB 610 requests the UE 600 to generate a UECapabilityInformation message via the UECapabilityEnquiry message, the gNB 610 may include filtering information for indicating conditions and restrictions. Here, the gNB 610 may indicate, via the filtering information, the UE 600 as to whether the UE 600 has to report whether the UE 600 supports a DSR.

In operation 630, the UE 600 may configure the UECapabilityInformation message corresponding to the UECapabilityEnquiry message, and may report a response to the UECapabilityEnquiry message to the gNB 610. Here, the UECapabilitylnformation message may include a parameter/an indicator indicating whether the UE 600 supports a DSR. For example, the parameter or the indicator may be 1 bit information. According to another embodiment of the disclosure, it may be indicated that a DSR is supported when the parameter or the indicator is included, and it may be indicated that a DSR is not supported when the parameter or the indicator is not included.

The gNB 610 may determine whether the UE 600 supports a DSR, based on the received UECapabilityInformation message. When the gNB 610 determines that the UE 600 supports a DSR, in operation 640, the gNB 610 may include and transmit DSR-associated configuration in an RRCReconfiguration message. The UE 600 may apply the DSR-associated configuration included in the received RRCReconfiguration message. The DSR-associated configuration may include all DSR-associated configurations a BS can configure for a UE which are described in the disclosure.

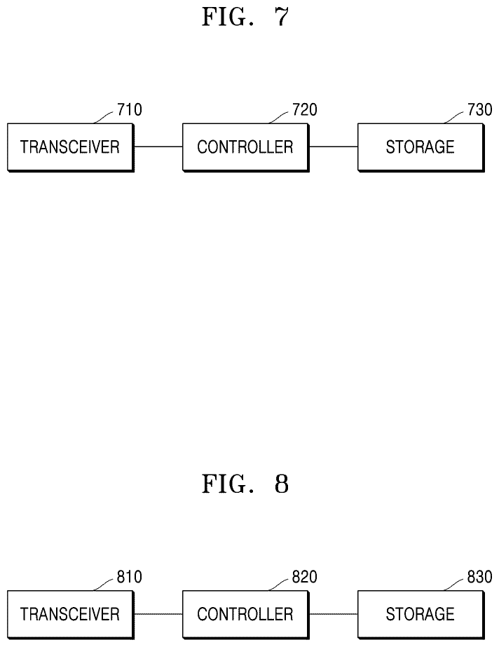

FIG. 7 illustrates a structure of a BS according to an embodiment of the present disclosure.

Referring to FIG. 7, the BS may include a transceiver 710, a controller 720, and a storage 730. According to the aforementioned communication schemes of the BS, the transceiver 710, the controller 720, and the storage 730 may operate. Also, a network entity may also correspond to the structure of the BS. However, elements of the BS are not limited to the example above. For example, the BS may include more elements than the aforementioned elements or may include fewer elements than the aforementioned elements. For example, the BS may include the transceiver 710 and the controller 720. In addition, the transceiver 710, the controller 720, and the storage 730 may be implemented as one chip.

A transmitter of the BS and a receiver of the BS may be collectively referred to as the transceiver 710, and the transceiver 710 may transmit or receive signals to or from a UE, other BS, or other network entities. Here, the transmitted or received signals may include control information and data. The transceiver 710 may transmit system information to the UE, and may transmit a synchronous signal or a reference signal. To this end, the transceiver 710 may include a radio frequency (RF) transmitter for up-converting and amplifying a frequency of signals to be transmitted, and an RF receiver for low-noise-amplifying and down-converting a frequency of received signals. However, this is merely an example of the transceiver 710, and thus elements of the transceiver 710 are not limited to the RF transmitter and the RF receiver. The transceiver 710 may include a wired/wireless transceiver, and may include various configurations for transmitting and receiving signals. Also, the transceiver 710 may receive signals via communication channels (e.g., wireless channels) and output the signals to the controller 720, and may transmit signals output from the controller 720, via communication channels. Also, the transceiver 710 may receive and output a communication signal to a processor, and may transmit a signal output from the processor to a UE, other BS, or other network entity via wired/wireless networks.

The storage 730 may store programs and data necessary for operations of the BS. Also, the storage 730 may store control information or data which are included in a signal obtained by the BS. The storage 730 may be implemented as a storage medium including a read only memory (ROM), a random access memory (RAM), a hard disk, a compact disc (CD)-ROM, a digital versatile disc (DVD), or the like, or any combination thereof. Also, the storage 730 may store at least one of information transmitted or received via the transceiver 710 or information generated by the controller 720.

In the disclosure, the controller 720 may be defined as a circuit or application-specific integrated circuit or at least one processor. The processor may include a communication processor (CP) for performing control for communication, and an application processor (AP) for controlling an upper layer such as an application program, etc. The controller 720 may control all operations of the BS according to an embodiment of the disclosure. For example, the controller 720 may control a signal flow between blocks so as to perform operations according to flowcharts described above.

FIG. 8 illustrates a structure of a UE according to an embodiment of the present disclosure.

Referring to FIG. 8, the UE may include a transceiver 810, a controller 820, and a storage 830. According to the aforementioned communication schemes of the UE, the transceiver 810, the controller 820, and the storage 830 may operate. However, elements of the UE are not limited to the example above. For example, the UE may include more elements than the aforementioned elements or may include fewer elements than the aforementioned elements. For example, the UE may include the transceiver 810 and the controller 820. In addition, the transceiver 810, the controller 820, and the storage 830 may be implemented as one chip.

A transmitter of the UE and a receiver of the UE may be collectively referred to as the transceiver 810, and the transceiver 810 may transmit or receive signals to or from a BS, other UE, or other network entity. Here, the signals transmitted or received to or from the BS may include control information and data. The transceiver 810 may receive system information from the BS, and may receive a synchronous signal or a reference signal. To this end, the transceiver 810 may include an RF transmitter for up-converting and amplifying a frequency of signals to be transmitted, and an RF receiver for low-noise-amplifying and down-converting a frequency of received signals. However, this is merely an example of the transceiver 810, and thus, elements of the transceiver 810 are not limited to the RF transmitter and the RF receiver. The transceiver 810 may include the wired/wireless transceiver 810, and may include various configurations for transmitting and receiving signals. Also, the transceiver 810 may receive signals via wireless channels and output the signals to the controller 820, and may transmit signals output from the controller 820, via wireless channels. Also, the transceiver 810 may receive and output a communication signal to a processor, and may transmit a signal output from the processor to a network entity via wired/wireless networks.

The storage 830 may store programs and data necessary for operations of the UE. Also, a memory may store control information or data which are included in a signal obtained by the UE. The storage 830 may be implemented as a storage medium including a ROM, a RAM, a hard disk, a CD-ROM, a DVD, or the like, or any combination thereof.

In the disclosure, the controller 820 may be defined as a circuit or application-specific integrated circuit or at least one processor. The processor may include a CP for performing control for communication, and an AP for controlling an upper layer such as an application program, etc. The controller 820 may control all operations of the BS according to an embodiment of the disclosure. For example, the controller 820 may control a signal flow between blocks so as to perform operations according to flowcharts described above.

The methods according to the embodiments of the disclosure as described in claims or specification may be implemented as hardware, software, or a combination of hardware and software.

When implemented as software, a computer-readable storage medium storing one or more programs (e.g., software modules) may be provided. The one or more programs stored in the computer-readable storage medium are configured for execution by one or more processors in an electronic device. The one or more programs include instructions directing the electronic device to execute the methods according to the embodiments of the disclosure as described in the claims or the specification.

The programs (e.g., software modules or software) may be stored in non-volatile memory including a RAM or a flash memory, a ROM, electrically erasable programmable read only memory (EEPROM), a magnetic disc storage device, a CD-ROM, a DVD, another optical storage device, or a magnetic cassette. Alternatively, the programs may be stored in memory including a combination of some or all of the above-mentioned storage media. Also, a plurality of such memories may be included.

In addition, the programs may be stored in an attachable storage device accessible via any or a combination of communication networks such as Internet, an intranet, a local area network (LAN), a wide LAN (WLAN), a storage area network (SAN), or the like. Such a storage device may access, via an external port, a device performing the embodiments of the disclosure. Furthermore, a separate storage device on the communication network may access the device performing the embodiments of the disclosure.

In the afore-described embodiments of the disclosure, elements included in the disclosure are expressed in a singular or plural form according to the embodiments of the disclosure. However, the singular or plural form is appropriately selected for convenience of descriptions and the disclosure is not limited thereto. As such, an element expressed in a plural form may also be configured as a single element, and an element expressed in a singular form may also be configured as plural elements.

Specific embodiments of the disclosure are described in the descriptions of the disclosure, but it will be understood that various modifications may be made without departing the scope of the disclosure. Thus, the scope of the disclosure is not limited to the embodiments described herein and should be defined by the appended claims and their equivalents.

According to an embodiment of the disclosure, a BS may efficiently allocate a UL resource, based on information transmitted from a UE.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving, from a base station (BS), a radio resource control (RRC) message configuring a remaining time threshold for a delay status report (DSR);
identifying a packet data convergence protocol (PDCP) service data unit (SDU) associated with the DSR based on the remaining time threshold;
determining a PDCP data volume to be indicated to at least one medium access control (MAC) entity based on the PDCP SDU associated with the DSR; and
transmitting, to the BS, a DSR MAC control element (CE) based on the PDCP data volume.

2. The method of claim 1, wherein the PDCP SDU associated with the DSR is a PDCP SDU for which a remaining time till discard timer expiry is less than the remaining time threshold.

3. The method of claim 1, wherein the PDCP SDU associated with the DSR is a PDCP SDU belonging to a PDU set of which another PDCP SDU has a remaining time till discard timer expiry less than the remaining time threshold.

4. The method of claim 1, wherein the PDCP data volume is determined based on the PDCP SDU associated with DSR for which no PDCP data protocol data unit (PDU) has been constructed.

5. The method of claim 1, wherein the PDCP data volume is determined based on a PDCP data PDU corresponding to the PDCP SDU associated with DSR that has not been submitted to lower layers.

6. The method of claim 1, further comprising, in case that a PDCP duplication is activated, indicating the PDCP data volume to a MAC entity associated with a primary radio link control (RLC).

7. The method of claim 1, further comprising, in case that a PDCP duplication is activated:
indicating the PDCP data volume excluding a PDCP control PDU to a MAC entity associated with a RLC entity other than a primary radio link control (RLC) entity activated for the PDCP duplication; and
indicating the PDCP data volume as 0 to a MAC entity associated with a RLC entity deactivated for the PDCP duplication.

8. The method of claim 1, further comprising, in case that a PDCP duplication is deactivated:
in case that a split secondary RLC entity is configured and a total amount of the PDCP data volume and a RLC data volume pending for initial transmission in a primary radio link control (RLC) entity and the split secondary RLC entity is equal to or larger than a specific threshold configured by the BS, indicating the PDCP data volume to both a MAC entity associated with the primary RLC entity and a MAC entity associated with the split secondary RLC entity and indicating the PDCP data volume as 0 to a MAC entity associated with a RLC entity other than the primary RLC entity and the split secondary RLC entity.

9. The method of claim 1, further comprising, in case that a PDCP duplication is deactivated:
in case that a split secondary RLC entity is not configured or a total amount of the PDCP data volume and a RLC data volume pending for initial transmission in a primary radio link control (RLC) entity and the split secondary RLC entity is lower than a specific threshold configured by the BS, indicating the PDCP data volume to a MAC entity associated with the primary RLC entity and indicating the PDCP data volume as 0 to a MAC entity associated with a RLC entity other than the primary RLC entity.

10. The method of claim 1, further comprising:
identifying at least one of an RLC SDU or an RLC SDU segment associated with the DSR based on an indication by a PDCP entity; and
determining an RLC data volume to be indicated to the at least one MAC entity based on the at least one of the RLC SDU or the RLC SDU segment associated with the DSR,
wherein the RLC data volume is determined based on the RLC SDU and the RLC SDU segment associated with the DSR that have not been included in an RLC data PDU, based on an RLC data PDU pending for initial transmission.

11. A user equipment (UE) in a wireless communication system, the UE comprising:
a transceiver; and
a controller configured to:
receive, from a base station (BS) via the transceiver, a radio resource control (RRC) message configuring a remaining time threshold for a delay status report (DSR),
identify a packet data convergence protocol (PDCP) service data unit (SDU) associated with the DSR based on the remaining time threshold,
determine a PDCP data volume to be indicated to at least one medium access control (MAC) entity based on the PDCP SDU associated with the DSR, and
transmit, to the BS via the transceiver, a DSR MAC control element (CE) based on the PDCP data volume.

12. The UE of claim 11, wherein the PDCP SDU associated with the DSR is a PDCP SDU for which a remaining time till discard timer expiry is less than the remaining time threshold.

13. The UE of claim 11, wherein the PDCP SDU associated with the DSR is a PDCP SDU belonging to a PDU set of which another PDCP SDU has a remaining time till discard timer expiry less than the remaining time threshold.

14. The UE of claim 11, wherein the PDCP data volume is determined based on the PDCP SDU associated with DSR for which no PDCP data protocol data unit (PDU) has been constructed.

15. The UE of claim 11, wherein the PDCP data volume is determined based on a PDCP data PDU corresponding to the PDCP SDU associated with DSR that has not been submitted to lower layers.

16. The UE of claim 11, wherein the controller is further configured to, in case that a PDCP duplication is activated, indicate the PDCP data volume to a MAC entity associated with a primary radio link control (RLC).

17. The UE of claim 11, wherein the controller is further configured to, in case that a PDCP duplication is activated:
indicate the PDCP data volume excluding a PDCP control PDU to a MAC entity associated with a RLC entity other than a primary radio link control (RLC) entity activated for the PDCP duplication, and
indicate the PDCP data volume as 0 to a MAC entity associated with a RLC entity deactivated for the PDCP duplication.

18. The UE of claim 11, wherein the controller is further configured to, in case that a PDCP duplication is deactivated:
in case that a split secondary RLC entity is configured and a total amount of the PDCP data volume and a RLC data volume pending for initial transmission in a primary RLC entity and the split secondary RLC entity is equal to or larger than a specific threshold configured by the BS, indicate the PDCP data volume to both a MAC entity associated with the primary RLC entity and a MAC entity associated with the split secondary RLC entity and indicate the PDCP data volume as 0 to a MAC entity associated with a RLC entity other than the primary RLC entity and the split secondary RLC entity.

19. The UE of claim 11, wherein the controller is further configured to, in case that a PDCP duplication is deactivated:
in case that a split secondary RLC entity is not configured or a total amount of the PDCP data volume and a RLC data volume pending for initial transmission in a primary radio link control (RLC) entity and the split secondary RLC entity is lower than a specific threshold configured by the BS, indicate the PDCP data volume to a MAC entity associated with the primary RLC entity and indicate the PDCP data volume as 0 to a MAC entity associated with a RLC entity other than the primary RLC entity.

20. The UE of claim 11, wherein the controller is further configured to:
identify at least one of an RLC SDU or an RLC SDU segment associated with the DSR based on an indication by a PDCP entity; and
determine an RLC data volume to be indicated to the at least one MAC entity based on the at least one of the RLC SDU or the RLC SDU segment associated with the DSR,
wherein the RLC data volume is determined based on the RLC SDU and the RLC SDU segment associated with the DSR that have not been included in an RLC data PDU, and based on an RLC data PDU pending for initial transmission.
